(19) United States
(12) Patent Application Publication
(10) Pub. No.: US 2023/0325910 A1
(43) Pub. Date: Oct. 12, 2023

(54) Method for Constructing 3D Virtual Mall

(71) Applicant: Yu-Tang FANG, Taichung City (TW)

(72) Inventor: Yu-Tang FANG, Taichung City (TW)

(21) Appl. No.: 18/297,374

(22) Filed: Apr. 7, 2023

(30) Foreign Application Priority Data
Apr. 8, 2022 (TW) 111113484

(51) Int. Cl. G06Q 30/0601; G06T 15/00; G06K 7/14

(52) U.S. Cl. CPC G06Q 30/0643; G06T 15/00; G06K 7/1417; G06K 7/1443

(57) ABSTRACT

A method for constructing a 3D virtual mall comprising following steps of: creating a data-set including a plurality of commodity-information corresponding to a plurality of commodities; making a plurality of physical-identification-labels corresponding to the commodities and setting the physical-identification-labels to be corresponding to the commodity-information; arranging the physical-identification-labels and the commodities in a plurality of corresponding shelf-compartments in a physical-mall; performing a spatial-image-scan in the physical-mall to obtain an image-set including a plurality of physical-identification-label-images of the physical-identification-labels; generating a 3D-image-space corresponding to the physical-mall from the image-set; and performing image recognition to identify the physical-identification-label-images in the 3D-image-space, and automatically generating a plurality of virtual-identification-labels corresponding to the physical-identification-label-images in the 3D-image-space, and automatically setting the virtual-identification-labels to be linked to the corresponding commodity-information, so as to construct the 3D virtual mall, wherein the 3D virtual mall comprises the 3D-image-space and the virtual-identification-labels.

### FIELD OF THE INVENTION

The present invention is related to a method for constructing a 3D virtual mall, especially a method for constructing a 3D virtual mall that automatically generates virtual identification labels and automatically sets the virtual identification labels to be linked to commodity information.

### BACKGROUND OF THE INVENTION

A method of constructing a 3D virtual mall of conventional technology comprises following steps of: Step 1: first arranging a plurality of commodities (for example, commodities A, B, C, . . . ) in a corresponding plurality of shelf compartments (for example, shelf compartments A, B, C, . . . ; wherein the shelf compartments A, B, C, . . . are corresponding to the commodities A, B, C, . . . ) in a physical mall; Step 2: performing a spatial image scan on the physical mall to obtain an image set; Step 3: generating a 3D image space from the image set, wherein the 3D image space is corresponding to the physical mall (there is a lot of image software or Apps that can provide such a function, and the image set can be input into these image software or Apps to generate a 3D image space); Step 4: finding the locations of a plurality of commodity images in the 3D image space one by one by reviewing with the naked eye, wherein the plurality of commodity images is corresponding to the plurality of commodities respectively (for example, a commodity image A is the image of the commodity A; a commodity image B is the image of the commodity B; a commodity image C is the image of the commodity C); then generating a plurality of virtual labels one by one at the locations of the plurality of commodity images in the 3D image space respectively, wherein the plurality of virtual labels is corresponding to the plurality of commodity images respectively (for example, generating virtual label A at the location of commodity image A; generating virtual label B at the location of commodity image B; generating virtual label C at the location of commodity image C; . . . ); then one by one setting the plurality of virtual labels to be linked to a plurality of commodity information of the corresponding plurality of commodities (for example, setting virtual label A to be linked to commodity information A; setting virtual label B to be linked to commodity information B; setting virtual label C to be linked to commodity information C; . . . ). When a consumer browses the 3D virtual mall through an interface (such as a screen of a computer that can be connected to the internet), he can watch it from different angles in the 3D virtual mall. When he clicks or triggers (for example, click or triggers with a mouse, or touches or triggers with a finger) the virtual label A in the virtual label A, it is linked to the commodity information A of the commodity A. The commodity information (relevant commodity information) A of commodity A is immediately displayed on the screen for consumer's reference.

Through the Step 4, to find the locations of the plurality of commodity images in the 3D image space one by one by reviewing with the naked eye; then to generate a plurality of virtual labels one by one; and then to set the plurality of virtual labels one by one to be linked to the plurality of commodity information of the corresponding plurality of commodities. Since there are too many kinds of commodities in the physical mall (too many commodity images in the 3D image space), such a process will consume a lot of manpower and time costs. In addition, because there are so many kinds of commodities and they are very diverse, and the packaging of the commodities will be constantly updated; hence, it is actually very difficult to one by one identify the plurality of commodity images (corresponding to the plurality of commodities) in the 3D image space by means of image recognition, and it is very difficult to achieve in practice.

Accordingly, the present invention has developed a new design which may avoid the above-described drawbacks, may significantly enhance the performance of the devices and may take into account economic considerations. Therefore, the present invention then has been invented.

### SUMMARY OF THE INVENTION

The main technical problems that the present invention is seeking to solve is how to automatically generate virtual identification labels by means of image recognition, and automatically set the virtual identification labels to be linked to commodity information, so as to save huge manpower consumption and the costs.

In order to solve the above described problems and to achieve the expected effect, the present invention provides a method for constructing a 3D virtual mall, which comprises following steps of: Step A: creating a data set, wherein the data set comprises a plurality of commodity information, wherein the plurality of commodity information is corresponding to a plurality of commodities respectively; Step B: making a plurality of physical identification labels, and setting the plurality of physical identification labels to be corresponding to the plurality of commodity information respectively, wherein the plurality of physical identification labels is corresponding to the plurality of commodities respectively; Step C: arranging the plurality of commodities in a plurality of shelf compartments in a physical mall respectively, wherein the plurality of shelf compartments is corresponding to the plurality of commodities respectively; Step D: arranging the plurality of physical identification labels in the plurality of shelf compartments in the physical mall respectively, wherein the plurality of physical identification labels is corresponding to the plurality of shelf compartments respectively; Step E: performing a spatial image scan in the physical mall to obtain an image set, wherein the image set comprises a plurality of physical identification label images of the plurality of physical identification labels, a plurality of commodity images of the plurality of commodities and a plurality of shelf compartment images of the plurality of shelf compartments; Step F: generating a 3D image space from the image set, wherein the 3D image space is corresponding to the physical mall, wherein the 3D image space comprises the plurality of physical identification label images, the plurality of commodity images and the plurality of shelf compartment images; and Step G: performing image recognition to identify the plurality of physical identification label images in the 3D image space, and automatically generating a plurality of virtual identification labels corresponding to the plurality of physical identification label images respectively in the 3D image space, so as to construct the 3D virtual mall, wherein the 3D virtual mall comprises the 3D image space and the plurality of virtual identification labels.

In implementation, in the Step G, the method further comprises a following step of: automatically setting the plurality of virtual identification labels to be linked to the plurality of commodity information respectively, wherein the plurality of virtual identification labels is corresponding to the plurality of commodity information respectively.

In implementation, each of the plurality of virtual identification labels and a corresponding one of the plurality of physical identification label images occupy a virtual identification label area and a physical identification label image area respectively in the 3D image space, the virtual identification label area is at least partially overlapped with the physical identification label image area.

In implementation, each of the plurality of virtual identification labels and a corresponding one of the plurality of physical identification label images occupy a virtual identification label area and a physical identification label image area respectively in the 3D image space, the virtual identification label area is adjacent to the physical identification label image area.

In implementation, the data set further comprises a plurality of virtual identification label settings, wherein the plurality of physical identification labels is set to be corresponding to the plurality of commodity information respectively and corresponding to the plurality of virtual identification label settings respectively.

In implementation, each of the plurality of virtual identification labels has a label type, wherein each of the plurality of virtual identification label settings comprises the label type.

In implementation, each of the plurality of virtual identification labels occupies a virtual identification label area, the virtual identification label area has a size range, wherein each of the plurality of virtual identification label settings comprises the size range of the virtual identification label area.

In implementation, each of the plurality of virtual identification labels is located at a relative position to a corresponding one of the plurality of physical identification label images, wherein each of the plurality of virtual identification label settings comprises the relative position.

In implementation, each of the plurality of virtual identification labels has a label type, each of the plurality of virtual identification labels occupies a virtual identification label area, the virtual identification label area has a size range, each of the plurality of virtual identification labels is located at a relative position to a corresponding one of the plurality of physical identification label images, wherein each of the plurality of virtual identification label settings comprises at least one of the label type, the size range of the virtual identification label area and the relative position.

In implementation, the data set further comprises a plurality of second relative positions corresponding to the plurality of physical identification labels; wherein before the Step E, the method further comprises a following step of: arranging K physical reference pieces in the physical mall, wherein K≥1, each of the plurality of physical identification labels is located at a corresponding one of the plurality of second relative positions relative to one of the K physical reference pieces; wherein in the Step E, the image set comprises K physical reference piece images, wherein the K physical reference piece images are the images of the K physical reference pieces respectively; wherein after the Step F and before the Step G, the method further comprises a following step of: performing image recognition to identify the K physical piece images in the 3D image space, and obtaining a position of each of the plurality of physical identification label images in the 3D image space through the plurality of second relative positions and a position of each of the K physical piece images in the 3D image space.

In implementation, each of the K physical reference pieces further comprises a wireless positioning module, wherein K≥3.

In implementation, before the Step E, the method further comprises a following step of: arranging N wireless positioning modules on N shelf compartments of the plurality of shelf compartments in the physical mall respectively, wherein the N wireless positioning modules are corresponding to the N shelf compartments of the plurality of shelf compartments respectively, wherein N≥3.

In implementation, after the N wireless positioning modules are arranged in the physical mall, the method further comprises a following step of: positioning a relative position between each of the N wireless positioning modules; wherein when a consumer is shopping in the physical mall and browsing the 3D virtual mall through a mobile device with a wireless positioning module, a location of the consumer in the physical mall can be calculated through the N wireless positioning modules in the physical mall and the wireless positioning module of the mobile device, and the location of the consumer in the physical mall can be displayed in the 3D virtual mall.

In implementation, the N shelf compartments are corresponding to N physical identification labels of the plurality of physical identification labels respectively, wherein the N wireless positioning modules are combined with the N physical identification labels of the plurality of physical identification labels respectively.

In implementation, the plurality of physical identification labels is at least one selected from the following groups: a QR code, a color pattern, a light signal arrangement, and a combination thereof.

For further understanding the characteristics and effects of the present invention, some preferred embodiments referred to drawings are in detail described as follows.

### BRIEF DESCRIPTION OF DRAWINGS

FIG. 1 is a schematic diagram of an embodiment of a 3D virtual mall constructed by a method for constructing the 3D virtual mall of the present invention.

FIG. 2 is a schematic diagram of triggering the virtual identification label in FIG. 1 to link to the corresponding commodity information.

FIG. 3 is a schematic perspective view of FIG. 1.

FIG. 4 is a schematic diagram of an embodiment of a physical identification label of the present invention.

FIG. 5 is a schematic diagram of another embodiment of a physical identification label of the present invention.

FIG. 6 is a schematic diagram of another embodiment of a physical identification label of the present invention.

FIG. 7 is a schematic diagram of another embodiment of a physical identification label of the present invention.

FIG. 8 is a schematic diagram of an embodiment of a physical identification label of the present invention combined with a paper label.

FIG. 9 is a schematic diagram of an embodiment of a physical identification label of the present invention combined with an electronic tag.

### DETAILED DESCRIPTIONS OF PREFERRED EMBODIMENTS

The present invention provides a method for constructing a 3D virtual mall, which comprises following steps of: Step A: creating a data set, wherein the data set comprises a plurality of commodity information and a plurality of virtual identification label settings, wherein the plurality of commodity information is corresponding to a plurality of commodities respectively; Step B: making a plurality of physical identification labels of the plurality of commodities respectively, and setting the plurality of physical identification labels to be corresponding to the plurality of commodity information and the plurality of virtual identification label settings respectively, wherein the plurality of physical identification labels is corresponding to the plurality of commodities respectively; Step C: arranging the plurality of commodities in a plurality of shelf compartments in a physical mall respectively, wherein the plurality of shelf compartments is corresponding to the plurality of commodities respectively; Step D: arranging the plurality of physical identification labels in the plurality of shelf compartments in the physical mall respectively, wherein the plurality of physical identification labels is corresponding to the plurality of shelf compartments respectively; Step E: performing a spatial image scan in the physical mall to obtain an image set, wherein the image set comprises a plurality of physical identification label images of the plurality of physical identification labels, a plurality of commodity images of the plurality of commodities and a plurality of shelf compartment images of the plurality of shelf compartments; Step F: generating a 3D image space from the image set, wherein the 3D image space is corresponding to the physical mall, wherein the 3D image space comprises the plurality of physical identification label images, the plurality of commodity images and the plurality of shelf compartment images; and Step G: performing image recognition to identify the plurality of physical identification label images in the 3D image space (to identify that the plurality of physical identification label images in the 3D image space are the images of the plurality of physical identification labels), and automatically generating a plurality of virtual identification labels corresponding to the plurality of physical identification label images respectively in the 3D image space (the plurality of virtual identification labels is corresponding to the plurality of physical identification label images), and automatically setting the plurality of virtual identification labels to be linked to the plurality of commodity information respectively (the plurality of virtual identification labels is corresponding to the plurality of commodity information respectively), so as to construct the 3D virtual mall, wherein the 3D virtual mall comprises the 3D image space and the plurality of virtual identification labels. A setting information of each of the plurality of virtual identification labels is stored in a corresponding one of the plurality of virtual identification label settings (the plurality of virtual identification labels is corresponding to the plurality of virtual identification label settings respectively). For example, each of the plurality of virtual identification labels is located at a relative position to (adjacent to) the corresponding one of the plurality of physical identification label images; each of the plurality of virtual identification labels has a label type; each of the plurality of virtual identification labels occupies a virtual identification label area in the 3D image space, the virtual identification label area has a size range, wherein the setting information of the relative position, the label type and the size range of the virtual identification label area is stored in the corresponding one of the plurality of virtual identification label settings.

Taking a commodity A as an example, firstly, the present invention makes a physical identification label A corresponding to the commodity A; and creates a data set, wherein the data set comprises a commodity information A corresponding to the commodity A (i.e., the commodity information A is corresponding to the physical identification label A) and a virtual identification label setting A corresponding to the physical identification label A. The setting information of a relative position of the virtual identification label A (referring to Step G) and the physical identification label image A (referring to Step E), a label type of the virtual identification label A, and a size range of a virtual identification label area that the virtual identification label A occupied in the 3D image space is stored in the virtual identification label setting A. In the Step B, the plurality of physical identification labels is made and is set to be corresponding to the plurality of commodity information and the plurality of virtual identification label settings of the data set, respectively. Therefore, when one of the physical identification label image is identified as the image of a corresponding one of the plurality of physical identification labels, then a corresponding one of the plurality of commodity information and a corresponding one of the plurality of virtual identification label settings are obtained. For example, the physical identification label A is set to be corresponding to the commodity information A and the virtual identification label setting A of the data set; in the 3D image space, when the physical identification label image A is identified as the image of the physical identification label A, the corresponding commodity information A and the virtual identification label setting A is obtained from the data set. Since the plurality of physical identification labels have been scanned into the plurality of physical identification label images in the Step E; then, in the Step G, image recognition is performed to identify that the plurality of physical identification label images are the images of the plurality of physical identification labels in the 3D image space. Hence, the plurality of commodity information and the plurality of virtual identification label settings corresponding to the plurality of physical identification labels are obtained from the data set. Then the setting information of the relative position, the label type, and the size range of the virtual identification label area are obtained from the plurality of virtual identification label settings corresponding to the plurality of physical identification labels. And then, according to the setting information (the relative position, the label type, and the size range of the virtual identification label area), automatically generating the plurality of virtual identification labels in the 3D image space; and automatically setting the plurality of virtual identification labels to be linked to the corresponding plurality of commodity information respectively. For example, when the commodity information A and the virtual identification label setting A of the physical identification label A are obtained, the setting information of the relative position, the label type, and the size range of the virtual identification label area are obtained from the virtual identification label setting A. And according to the setting information (the relative position, the label type, and the size range of the virtual identification label area), the virtual identification label A is automatically generated in the 3D image space; and the virtual identification label A is automatically set to be linked to the corresponding commodity information A, so as to construct the 3D virtual mall, wherein the 3D virtual mall comprises the 3D image space and the plurality of virtual identification labels. Through the plurality of virtual identification labels, consumers can link to the plurality of commodity information corresponding to the plurality of virtual identification labels. For example, when a consumer browses the 3D virtual mall constructed by the present invention through an interface (such as a screen of a computer that can be connected to the internet), he can view the 3D virtual mall from different angles. When he is interested in the commodity A and clicks or triggers (for example, clicks or triggers with a mouse, or touched or triggers with a finger) the virtual identification label A in the 3D virtual mall, it will be linked to the commodity information A (for example, the commodity information A of the commodity A is immediately displayed on the screen) for consumer's consumption reference. In the 3D virtual mall constructed by the method for constructing the 3D virtual mall of the present invention, consumers can use mobile phones, tablets, computers, and AR augmented reality displays (for example, head mounted augmented reality displays, or augmented reality glasses), or a VR virtual reality display (for example, head mounted virtual reality display, or virtual reality glasses) for browsing.

For example, if the plurality of commodities comprises the commodity A, the commodity B and the commodity C. The commodity information A, the commodity information B and the commodity information C are corresponding to the commodity A, the commodity B and the commodity C respectively. The physical identification label A, the physical identification label B and the physical identification label C are corresponding to the commodity A, the commodity B and the commodity C respectively. The data set comprises the commodity information A, the commodity information B, the commodity information C, the virtual identification label setting A, the virtual identification label setting B, and the virtual identification label setting C. In the physical mall, the commodity A and the physical identification label A are arranged in the shelf compartment A; the commodity B and the physical identification label B are arranged in the shelf compartment B; the commodity C and the physical identification label C are arranged in the shelf compartment C (i.e., the shelf compartment A, the shelf compartment B and the shelf compartment C are corresponding to the commodity A, the commodity B and the commodity C respectively; and are corresponding to the physical identification label A, the physical identification label B and the physical identification label C respectively). Performing image scan (the Step E) in the physical identification label A, the physical identification label B and the physical identification label C and then performing image recognition (the Step G), and then the physical identification label image A, the physical identification label image B and the physical identification label image C are identified (recognized) as the images of the physical identification label A, the physical identification label B and the physical identification label C respectively; hence, ; and the physical identification label image A, the physical identification label image B and the physical identification label image C are also corresponding to the virtual identification label setting A, the virtual identification label setting B, and the virtual identification label setting C respectively. In the Step G, the virtual identification label A, the virtual identification label B and the virtual identification label C are automatically generated corresponding to the physical identification label image A, the physical identification label image B and the physical identification label image C respectively. The setting information related to the virtual identification label A is stored in the virtual identification label setting A; the setting information related to the virtual identification label B is stored in the virtual identification label setting B; setting information related to the virtual identification label C is stored in the virtual identification label setting C. And in the Step G, the virtual identification label A is automatically set to be linked to the commodity information A; the virtual identification label B is automatically set to be linked to the commodity information B; the virtual identification label C is automatically set to be linked to the commodity information C.

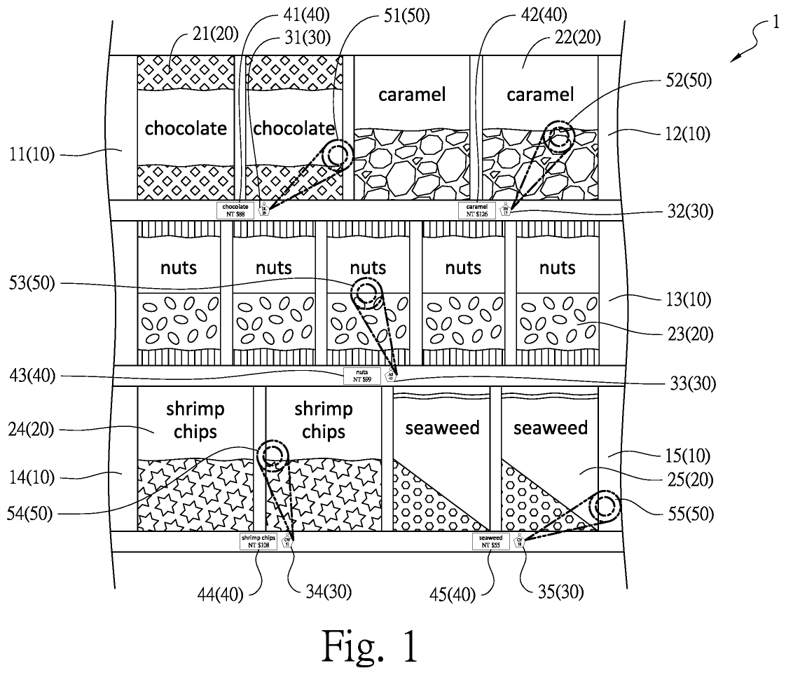

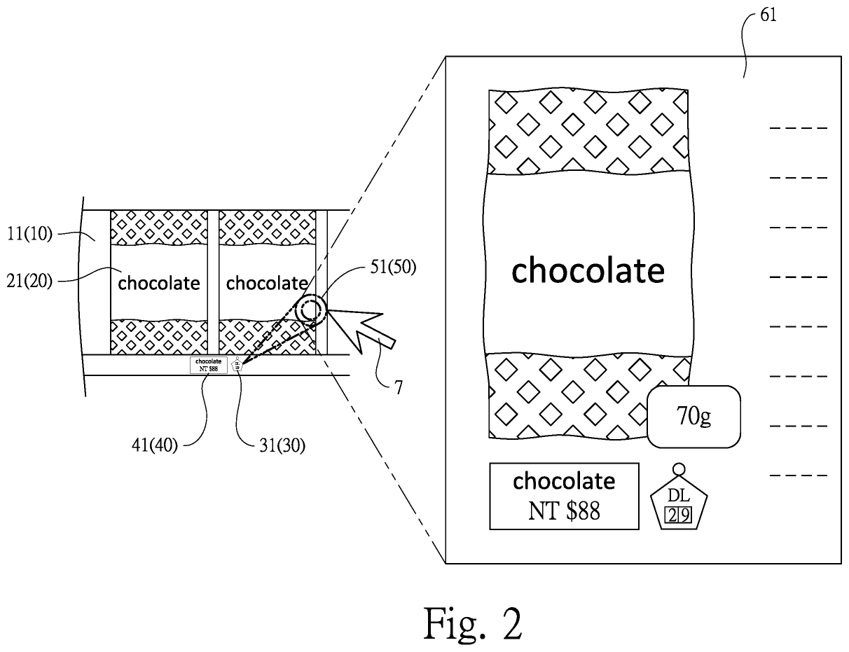

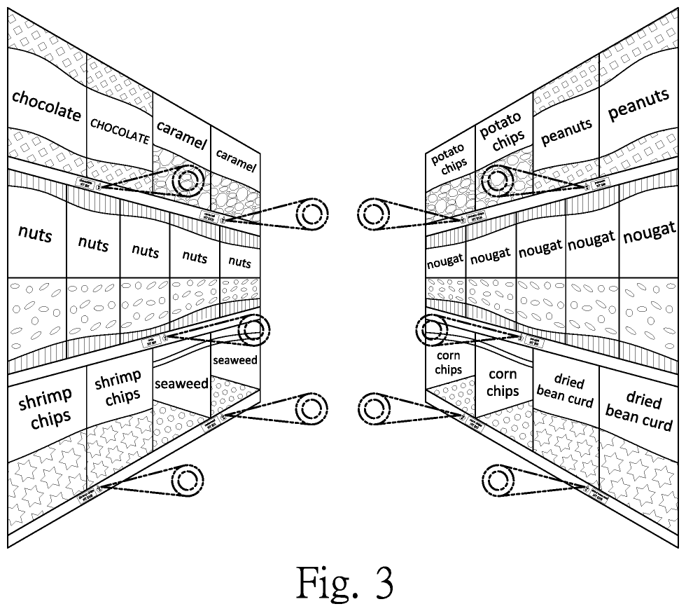

Please refer to FIG. 1, which shows a schematic diagram of an embodiment of a 3D virtual mall constructed by a method for constructing a 3D virtual mall of the present invention. Please also refer to FIG. 2 and FIG. 3, which show a schematic diagram of triggering the virtual identification label in FIG. 1 to link to the corresponding commodity information and a schematic perspective view of FIG. 1 respectively. The 3D virtual mall 1 comprises a 3D image space and a plurality of virtual identification labels 50 (i.e., removing the plurality of virtual identification labels 50 from the 3D virtual mall 1, the rest is the 3D image space). The plurality of virtual identification labels 50 comprises the virtual identification labels 51, 52, 53, 54 and 55. The 3D image space is corresponding to a physical mall (not shown in figure). The 3D image space comprises a plurality of shelf compartment images 10 (corresponding to a plurality of shelf compartments in the physical mall), a plurality of commodity images 20 (corresponding to a plurality of commodities in the physical mall), a plurality of physical identification label images 30 (corresponding to a plurality of physical identification labels in the physical mall), and a plurality of paper label images 40 (corresponding to a plurality of paper labels in the physical mall). The plurality of shelf compartment images 10 comprises the shelf compartment images 11, 12, 13, 14 and 15. The plurality of commodity images 20 comprises the commodity images 21, 22, 23, 24 and 25. The plurality of physical identification label images 30 comprises the physical identification label images 31, 32, 33, 34 and 35. The plurality of paper label images 40 comprises the paper label images 41, 42, 43, 44 and 45. The plurality of commodities, the plurality of physical identification labels and the plurality of paper labels are respectively arranged on the corresponding plurality of shelf compartments in the physical mall; therefore, the plurality of commodity images 20, the plurality of physical identification label images 30 and the plurality of paper label images 40 in the 3D image space are respectively arranged on the corresponding plurality of shelf compartment images 10. The plurality of virtual identification labels 50 are respectively arranged corresponding to the plurality of physical identification label images 30. Each of the virtual identification labels 50 is located at a relative position to (adjacent to) a corresponding one of the physical identification label images 30. Each of the virtual identification labels 50 has a label type. Each of the virtual identification labels 50 occupies a virtual identification label area in the 3D image space. The virtual identification label area has a size range. The setting information of the relative position, the label type, and the size range of the virtual identification label area of each of the virtual identification labels 50 is stored in a corresponding one of the virtual identification label settings. For example, the virtual identification label 51 is located at a relative position to (adjacent to) a corresponding physical identification label image 31. The virtual identification label 51 has label type. The virtual identification label 51 occupies a virtual identification label area in the 3D image space. The virtual identification label area has a size range. The setting information of the relative position, the label type, and the size range of the virtual identification label area of the virtual identification label 51 is stored in a corresponding virtual identification label setting. FIG. 3 is browsing the 3D virtual mall 1 from different angle. When consumer browses the 3D virtual mall 1, if he is interested in a certain commodity (for example, the image of the commodity is the commodity image 21), he can click or trigger (for example, click or trigger with a mouse, or touch or trigger with a finger) the virtual identification label 51 (in current embodiment, as shown in FIG. 2, moves the cursor 7 to the virtual identification label 51, and then clicks on the virtual identification label 51) corresponding to the commodity image 21 in the 3D image space. After the virtual identification label 51 is clicked or triggered, it will be linked to the commodity information 61 (as shown in FIG. 2), and the commodity information 61 (relevant commodity information) of the commodity will be immediately displayed for consumer's consumption reference. In current embodiment, the plurality of physical identification labels in the physical mall is not combined with the corresponding plurality of paper labels.

The present invention needs to make the corresponding plurality of physical identification labels for each commodity. In the Step G, image recognition is required to identify the plurality of physical identification label images in the 3D image space. However, due to the large number and variety of commodities in the physical mall, it is very messy. Therefore, if the physical identification label is not specially designed so that it has a specific identification feature, it will take a lot of time to identify the plurality of physical identification label images in the 3D image space (or the image set) when performing image recognition on the 3D image space (or the image set). Hence, in the present invention, the characteristic of the physical identification label made for commodity is that it has a specific identification feature, wherein the specific identification feature includes at least one selected from the following groups: a specific shape, a specific pattern, a specific color, a specific color distribution, a specific color pattern, a specific color pattern distribution, a light signal arrangement, a color light signal arrangement, and combinations thereof. The specific identification feature makes it easy to identify the plurality of physical identification label images in the 3D image space (or the image set) when performing image recognition on the 3D image space (or the image set). In some embodiments, the physical identification label can be a QR code.

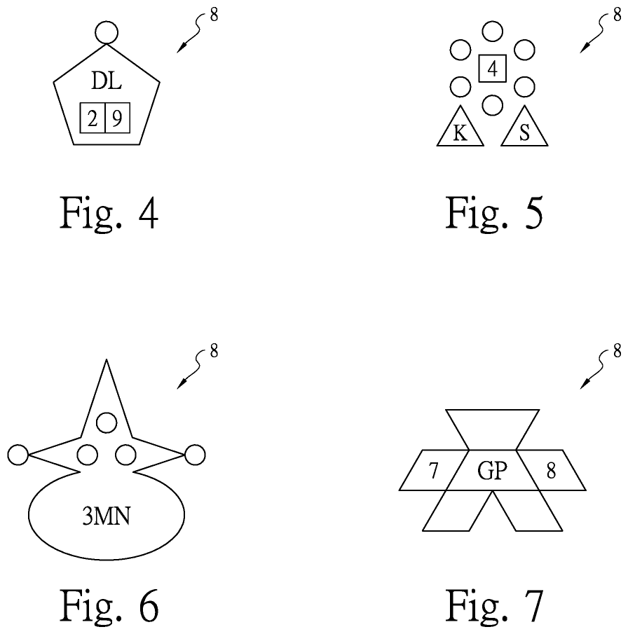

Please refer to FIGS. 4-7, which show schematic diagrams of four specific embodiments of the physical identification labels of the present invention. In the embodiment of FIG. 4, the shape of the physical identification label 8 of the present invention is a pentagon, plus a circle on the pentagon. There are two quadrilateral boxes in the pentagon. There is a number (it can also be English characters, Chinese characters, other character or symbols) in the two quadrilateral boxes respectively. Inside the pentagon, on top of the two quadrilateral boxes, there are two English characters (it can also be numbers, Chinese characters, other characters or symbols). When actually making the physical identification label 8, you can choose the color of the pentagon, the color of the left quadrilateral box, and the color of the right quadrilateral box to be all different, partially the same, or completely the same. You can choose the color of the pentagon to be the same or different from the color of the circle on the pentagon. You can also choose the colors of the numbers in the two quadrilateral boxes to be different from the colors of the two quadrilateral boxes. Also you can select the color of the two English characters and the color of the pentagon to be different. In some embodiments, the circle on the pentagon can be a light sign, and the color of the light sign can be selected to be the same as or different from the color of the pentagon. The variety of the color of the pentagon, the variety of the color of the two quadrilateral boxes, the variety of the color of the circle on the pentagon, the variety of the color of the English characters, the variety of the color of the numbers, the variety of the characters, and the variety of the numbers, all these varieties can be selected as the coding combination of the physical identification label 8 of the present invention.

In the embodiment of FIG. 5, the physical identification label 8 of the present invention is composed of two triangular lights with English character (it can also be numbers, Chinese characters, other characters or symbols), one quadrilateral light with number (it can also be English characters, Chinese characters, other characters or symbols) and six circular lights. When actually making the physical identification label 8, the color of the English characters of the two triangular can be selected to be different from the background color of the two triangular lights. You can also choose the color of the number of the quadrilateral light to be different from the background color of the quadrilateral light. The variety of the background color of the two triangular lights, the variety of the background color of the quadrilateral light, the variety of the color of the six circular lights, the variety of the color of the number, the variety of the color of the English characters, all these varieties can be selected as the coding combination of the physical identification label 8 of the present invention.

In the embodiment of FIG. 6, the physical identification label 8 of the present invention includes an ellipse in the lower half, a three-star shape in the upper half, a combination of three English characters and numbers (it can also be the combination of Chinese characters, other characters or symbols) in the oval, three circles in the three-star shape, and two circles on both sides of the three-star shape. The variety of the color of the oval, the variety of the color of the three-star shape, the variety of the color of the three circles in the three-star shape, the variety of the color of the two circles on both sides of the three-star shape, the variety of the combination of three English characters and numbers, all these varieties can be selected as the coding combination of the physical identification label 8 of the present invention.

In the embodiment of FIG. 7, the physical identification label 8 of the present invention includes a trapezoid on the top, a trapezoid in the middle, a parallelogram on each side of the trapezoid in the middle, a parallelogram on each side below the trapezoid in the middle, two English characters (it can also be numbers, Chinese characters, other characters or symbols) in the trapezoid in the middle, and a number (it can also be English characters, Chinese characters, other characters or symbols) in each parallelogram on each side of the trapezoid in the middle. The variety of the color of the trapezoid on the top, the variety of the color of the trapezoid in the middle, the variety of the color of the parallelogram on each side of the trapezoid in the middle, the variety of the color of the parallelogram on each side below the trapezoid in the middle, the variety of the color of the two English characters, the variety of the color of the two numbers, the variety of the English characters, the variety of the numbers, all these varieties can be selected as the coding combination of the physical identification label 8 of the present invention.

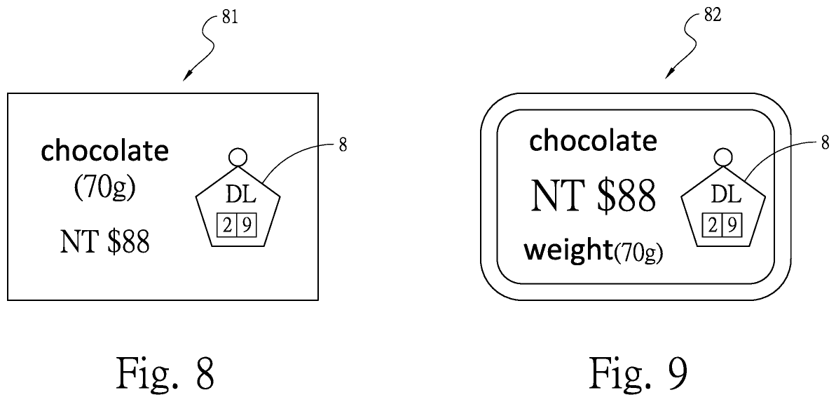

Please refer to FIG. 8, which shows a schematic diagram of an embodiment of a physical identification label of the present invention combined with a paper label. In current embodiment, the physical identification label 8 of the present invention is combined with the paper label 81 (for example, the physical identification label 8 is pasted on the paper label 81). In some other embodiments, the physical identification label 8 of the present invention and the paper label 81 are not combined together (as in the embodiment shown in FIG. 1).

Please refer to FIG. 9, which shows a schematic diagram of an embodiment of a physical identification label of the present invention combined with an electronic tag. In current embodiment, the electronic label 82 is used to replace the paper label 81 of the embodiment shown in FIG. 8, and the physical identification label 8 of the present invention is combined with the electronic label 82 (for example, the physical identification label 8 is pasted on the electronic label 82). In some embodiments, the physical identification label 8 and the electronic label 82 are not combined together.

In the Step G, after image identifying the plurality of physical identification label images in the 3D image space, a plurality of virtual identification labels is automatically generated in the 3D image space. However, where should the plurality of virtual identification labels be placed in the 3D image space? How large is the scope of each? In what type of label? These settings (the setting information) can be planned in advance. The setting information (these settings) can be stored in a plurality of virtual identification label settings in the data set in advance. The plurality of virtual identification label settings is corresponding to the plurality of virtual identification labels respectively. Each virtual identification label can have different label type, size ranges, and positions, depending on actual needs. These settings can be pre-set and stored in the plurality of virtual identification label settings in the data set.

In the Step F, there is a lot of image software or Apps that can provide such a function, and the image set can be input into these image software or Apps to generate a 3D image space.

In some embodiments, the data set can be stored in a storage device, a server or a cloud server.

In some embodiments, each of the plurality of virtual identification labels and a corresponding one of the plurality of physical identification label images occupy a virtual identification label area and a physical identification label image area respectively in the 3D image space (i.e., each virtual identification label occupies the virtual identification label area; the corresponding physical identification label image occupies the physical identification label image area), wherein the virtual identification label area is at least partially overlapped with the physical identification label image area.

In some embodiments, each of the plurality of virtual identification labels and a corresponding one of the plurality of physical identification label images occupy a virtual identification label area and a physical identification label image area respectively in the 3D image space (i.e., each virtual identification label occupies the virtual identification label area; the corresponding physical identification label image occupies the physical identification label image area), wherein the virtual identification label area is adjacent to the physical identification label image area.

In some embodiments, the data set further comprises a plurality of second relative positions corresponding to the plurality of physical identification labels; wherein before the Step E, the method for constructing the 3D virtual mall of the present invention further comprises a following step of: arranging K physical reference pieces in the physical mall, wherein K≥1, each of the plurality of physical identification labels is located at a corresponding one of the plurality of second relative positions relative to one of the K physical reference pieces; wherein in the Step E, the image set comprises K physical reference piece images, wherein the K physical reference piece images are the images of the K physical reference pieces; wherein after the Step F and before the Step G, the method further comprises a following step of: performing image recognition to identify the K physical piece images in the 3D image space, and obtaining a position of each of the plurality of physical identification label images in the 3D image space through the plurality of second relative positions and a position of each of the K physical piece images in the 3D image space. Taking K=3 as an example, before the Step E, arranging 3 physical reference pieces in the physical mall; these 3 physical reference pieces can be three specific color lights, and 3 physical reference pieces are arranged in the particularly conspicuous places in the physical mall, such as the top of three of the plurality of shelf compartments. Since the positions of these 3 physical reference pieces in the physical mall and the locations of the plurality of physical identification labels arranged in the physical mall can be planned in advance, and then actually arranged. Therefore, a relative position between each of the plurality of physical identification labels and one of the 3 physical reference pieces can be planned in advance. For example, each of the plurality of physical identification labels is arranged in a corner of a corresponding one of the plurality of shelf compartments (for example, the corner below the right front end), and the intervals between the plurality of shelf compartments are planned in advance. Hence, the relative position between each of the plurality of physical identification labels and one of the 3 physical reference pieces can be known (or measured) in advance. After performing image recognition to identify the K physical piece images in the 3D image space, a position of each of the plurality of physical identification labels in the 3D image space can be obtained from a position of each of the 3 physical piece images in the 3D image space and the plurality of second relative positions in the data set. Therefore, in the Step G, it will be easier to perform image recognition to identify the plurality of physical identification label images in the 3D image space; because the position of each of the plurality of physical identification label images in the 3D image space is already known (or at least known roughly position), and it only need to search for the plurality of physical identification label images in the 3D image space near these positions (the known positions of the plurality of physical identification label images), and then performing image recognition. In this way, a lot of time for image recognition can be saved.

In some embodiments, each of the K physical reference pieces further comprises a wireless positioning module, wherein K≥3. The wireless positioning module can self-position each other to locate the relative positions of each other in the physical mall. Furthermore, the wireless positioning module can also provide the navigation function of the physical mall for mobile devices of consumers when shopping in the physical mall.

In some embodiments, before the Step E, the method for constructing the 3D virtual mall of the present invention further comprises a following step of: arranging N wireless positioning modules on N shelf compartments of M shelf compartments (there are totally M shelf compartments in the physical mall) in the physical mall, wherein the N wireless positioning modules are corresponding to the N shelf compartments of the plurality of shelf compartments respectively, wherein M≥N≥3. The N wireless positioning modules can perform self-positioning with each other, so as to locate one of the relative positions of each other. When a consumer is shopping in the physical mall and browsing the 3D virtual mall 1 through a mobile device (for example, mobile phone), if the consumer's mobile device also has a wireless positioning module, then through the N wireless positioning modules in the physical mall and the wireless positioning module of the consumer's mobile device, the relative position between the consumer in the physical mall and the N wireless positioning modules can be located. And then the location of consumer in the physical mall can be calculated, and the location of consumer in the physical mall can be displayed in the 3D virtual mall. Hence, when the consumer clicks on the virtual identification label A in the physical mall, the mobile device will display the location of the commodity A (and commodity information A) corresponding to the virtual identification label A in the physical mall. In addition, it can also provide the navigation function in the 3D virtual mall 1 to guide the consumer from their location in the physical mall to the location of commodity A in the physical mall.

In some embodiments, the N shelf compartments are corresponding to N physical identification labels of the plurality of physical identification labels respectively, wherein the N wireless positioning modules are combined with the corresponding N physical identification labels respectively.

In some embodiments, before the Step E, the method for constructing the 3D virtual mall of the present invention further comprises a following step of: arranging P physical commodity labels on P shelf compartments of M shelf compartments (there are totally M shelf compartments in the physical mall) in the physical mall, wherein the P physical commodity labels are corresponding to the P shelf compartments of the plurality of shelf compartments respectively, wherein M≥P≥1. Each of the P physical commodity labels is one of an electronic label and a non-electric label. The P physical commodity labels are common product labels for consumers' reference in common physical mall (the P physical commodity labels are not the same as the physical identification labels of the present invention; the physical identification labels of the present invention are designed for facilitating image recognition).

In some embodiments, the P shelf compartments are corresponding to P physical identification labels of the plurality of physical identification labels, wherein the P physical commodity labels and the P physical identification labels are combined together.

Regarding the sequence of the Steps for implementing a method for constructing a 3D virtual mall of the present invention, wherein the sequence of executing the Steps B and D: the Step B must be executed before the Step D; wherein the sequence of executing the Steps E, F and G: the Step E must be executed before the Step F, and the Step G must be executed after the Step F; wherein the sequence of executing the Steps A, B, C and D can be: (1) the Step A, then the Step B, then the Step C, then the Step D, (2) the Step A, then the Step B, then the Step D, then the Step C, (3) the Step A, then the Step C, then the Step B, then the Step D, (4) the Step B, then the Step A, then the Step C, then the Step D, (5) the Step B, then the Step A, then the Step D, then the Step C, (6) the Step B, then the Step C, then the Step A, then the Step D, (7) the Step B, then the Step C, then the Step D, then the Step A, (8) the Step B, then the Step D, then the Step A, then the Step C, (9) the Step B, then the Step D, then the Step C, then the Step A, (10) the Step C, then the Step A, then the Step B, then the Step D, (11) the Step C, then the Step B, then the Step A, then the Step D, or (12) the Step C, then the Step B, then the Step D, then the Step A.

As disclosed in the above description and attached drawings, the present invention can provide a method for constructing a 3D virtual mall. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A method for constructing a 3D virtual mall, comprising following steps of:
Step A: creating a data set, wherein said data set comprises a plurality of commodity information, wherein said plurality of commodity information is corresponding to a plurality of commodities respectively;
Step B: making a plurality of physical identification labels, and setting said plurality of physical identification labels to be corresponding to said plurality of commodity information respectively, wherein said plurality of physical identification labels is corresponding to said plurality of commodities respectively;
Step C: arranging said plurality of commodities in a plurality of shelf compartments in a physical mall respectively, wherein said plurality of shelf compartments is corresponding to said plurality of commodities respectively;
Step D: arranging said plurality of physical identification labels in said plurality of shelf compartments in said physical mall respectively, wherein said plurality of physical identification labels is corresponding to said plurality of shelf compartments respectively;
Step E: performing a spatial image scan in said physical mall to obtain an image set, wherein said image set comprises a plurality of physical identification label images of said plurality of physical identification labels;
Step F: generating a 3D image space from said image set, wherein said 3D image space is corresponding to said physical mall; and
Step G: performing image recognition to identify said plurality of physical identification label images in said 3D image space, and automatically generating a plurality of virtual identification labels corresponding to said plurality of physical identification label images respectively in said 3D image space, so as to construct said 3D virtual mall, wherein said 3D virtual mall comprises said 3D image space and said plurality of virtual identification labels.

2. The method for constructing the 3D virtual mall according to claim 1, wherein each of said plurality of virtual identification labels and a corresponding one of said plurality of physical identification label images occupy a virtual identification label area and a physical identification label image area respectively in said 3D image space, said virtual identification label area is at least partially overlapped with said physical identification label image area.

3. The method for constructing the 3D virtual mall according to claim 1, wherein each of said plurality of virtual identification labels and a corresponding one of said plurality of physical identification label images occupy a virtual identification label area and a physical identification label image area respectively in said 3D image space, said virtual identification label area is adjacent to said physical identification label image area.

4. The method for constructing the 3D virtual mall according to claim 1, wherein said data set further comprises a plurality of virtual identification label settings, wherein said plurality of physical identification labels is set to be corresponding to said plurality of commodity information respectively and corresponding to said plurality of virtual identification label settings respectively.

5. The method for constructing the 3D virtual mall according to claim 4, wherein each of said plurality of virtual identification labels is located at a relative position to a corresponding one of said plurality of physical identification label images, wherein each of said plurality of virtual identification label settings comprises said relative position.

6. The method for constructing the 3D virtual mall according to claim 4, wherein each of said plurality of virtual identification labels has a label type, each of said plurality of virtual identification labels occupies a virtual identification label area, said virtual identification label area has a size range, each of said plurality of virtual identification labels is located at a relative position to a corresponding one of said plurality of physical identification label images, wherein each of said plurality of virtual identification label settings comprises at least one of said label type, said size range and said relative position.

7. The method for constructing the 3D virtual mall according to claim 1, wherein, in said Step G, said method further comprises a following step of: automatically setting said plurality of virtual identification labels to be linked to said plurality of commodity information respectively, wherein said plurality of virtual identification labels is corresponding to said plurality of commodity information respectively.

8. The method for constructing the 3D virtual mall according to claim 7, wherein each of said plurality of virtual identification labels and a corresponding one of said plurality of physical identification label images occupy a virtual identification label area and a physical identification label image area respectively in said 3D image space, said virtual identification label area is at least partially overlapped with said physical identification label image area.

9. The method for constructing the 3D virtual mall according to claim 7, wherein each of said plurality of virtual identification labels and a corresponding one of said plurality of physical identification label images occupy a virtual identification label area and a physical identification label image area respectively in said 3D image space, said virtual identification label area is adjacent to said physical identification label image area.

10. The method for constructing the 3D virtual mall according to claim 7, wherein said data set further comprises a plurality of virtual identification label settings, wherein said plurality of physical identification labels is set to be corresponding to said plurality of commodity information respectively and corresponding to said plurality of virtual identification label settings respectively.

11. The method for constructing the 3D virtual mall according to claim 10, wherein each of said plurality of virtual identification labels has a label type, wherein each of said plurality of virtual identification label settings comprises said label type.

12. The method for constructing the 3D virtual mall according to claim 10, wherein each of said plurality of virtual identification labels occupies a virtual identification label area, said virtual identification label area has a size range, wherein each of said plurality of virtual identification label settings comprises said size range of said virtual identification label area.

13. The method for constructing the 3D virtual mall according to claim 10, wherein each of said plurality of virtual identification labels is located at a relative position to a corresponding one of said plurality of physical identification label images, wherein each of said plurality of virtual identification label settings comprises said relative position.

14. The method for constructing the 3D virtual mall according to claim 10, wherein each of said plurality of virtual identification labels has a label type, each of said plurality of virtual identification labels occupies a virtual identification label area, said virtual identification label area has a size range, each of said plurality of virtual identification labels is located at a relative position to a corresponding one of said plurality of physical identification label images, wherein each of said plurality of virtual identification label settings comprises at least one of said label type, said size range of said virtual identification label area and said relative position.

15. The method for constructing the 3D virtual mall according to claim 7, wherein said data set further comprises a plurality of second relative positions corresponding to said plurality of physical identification labels; wherein before said Step E, said method further comprises a following step of: arranging K physical reference pieces in said physical mall, wherein K≥1, each of said plurality of physical identification labels is located at a corresponding one of said plurality of second relative positions relative to one of said K physical reference pieces; wherein in said Step E, said image set comprises K physical reference piece images, wherein said K physical reference piece images are the images of said K physical reference pieces respectively; wherein after said Step F and before said Step G, said method further comprises a following step of: performing image recognition to identify said K physical piece images in said 3D image space, and obtaining a position of each of said plurality of physical identification label images in said 3D image space through said plurality of second relative positions and a position of each of said K physical piece images in said 3D image space.

16. The method for constructing the 3D virtual mall according to claim 15, wherein each of said K physical reference pieces further comprises a wireless positioning module, wherein K≥3.

17. The method for constructing the 3D virtual mall according to claim 7, wherein before said Step E, said method further comprises a following step of: arranging N wireless positioning modules on N shelf compartments of said plurality of shelf compartments in said physical mall respectively, wherein said N wireless positioning modules are corresponding to said N shelf compartments of said plurality of shelf compartments respectively, wherein N≥3.

18. The method for constructing the 3D virtual mall according to claim 17, wherein after said N wireless positioning modules are arranged in said physical mall, said method further comprises a following step of: positioning a relative position between each of said N wireless positioning modules; wherein when a consumer is shopping in said physical mall and browsing said 3D virtual mall through a mobile device with a wireless positioning module, a location of said consumer in said physical mall can be calculated through said N wireless positioning modules in said physical mall and said wireless positioning module of said mobile device, and said location of said consumer in said physical mall can be displayed in said 3D virtual mall.

19. The method for constructing the 3D virtual mall according to claim 17, wherein said N shelf compartments are corresponding to N physical identification labels of said plurality of physical identification labels respectively, wherein said N wireless positioning modules are combined with said N physical identification labels of said plurality of physical identification labels respectively.

20. The method for constructing the 3D virtual mall according to claim 7, wherein said plurality of physical identification labels is at least one selected from the following groups: a QR code, a color pattern, a light signal arrangement, and a combination thereof.
